(19) United States
(12) Patent Application Publication
(10) Pub. No.: US 2024/0376572 A1
(43) Pub. Date: Nov. 14, 2024

(54) ALUMINUM ALLOY FOR CASTING AND ALUMINUM CASTING THAT IS PROVIDED BY USING AND CASTING IT

(71) Applicant: HINODE Holdings Co., Ltd., Fukuoka-shi, Fukuoka (JP)

(72) Inventor: Koki TAKEYA, Fukuoka (JP)

(73) Assignee: HINODE Holdings Co., Ltd., Fukuoka-shi, Fukuoka (JP)

(21) Appl. No.: 18/564,667

(22) PCT Filed: May 30, 2022
(86) PCT No.: PCT/JP2022/021863

§ 371 Date: Nov. 28, 2023

(30) Foreign Application Priority Data
Jun. 1, 2021 (JP) 2021-092126
Jun. 1, 2021 (JP) 2021-092127

(51) Int. Cl. C22C 21/16; C22C 21/02; C22C 21/14

(52) U.S. Cl. CPC C22C 21/16; C22C 21/02; C22C 21/14

(57) ABSTRACT

An aluminum alloy for casting includes 1.0 to 10.0 mass % of Ni, 8.01 to 18.0 mass % of Cu, 0.01 to 0.75 mass % of Mn, and a balance that is Al and an inevitable impurity/impurities.

### FIELD

The present invention relates to an aluminum alloy for casting and an aluminum casting that is provided by using and casting it, etc.

### BACKGROUND

Patent Literature 1 (International Publication No. 2015/152133) discloses an Al—Si—Mg-based aluminum alloy for casting that is composed of 12.0 to 14.0% of Si, 1.5 to 4.0% of Mg, 0.10% or less of Mn, and a balance that is Al and an inevitable impurity/impurities, in a mass scale, and is excellent in a specific stiffness, a strength, and a ductility thereof, and a casting member that is composed of it.

### CITATION LIST

### Patent Literature

Patent Literature 1: International Publication No. 2015/152133

### SUMMARY

### Technical Problem(s)

An aluminum alloy for casting that is high in a stiffness thereof and is also excellent in a tensile strength thereof is needed.

### Solution(s) to Problem(s)

An aspect of the present invention is an aluminum alloy for casting that includes 1.0 to 10.0 mass % of Ni, 8.01 to 18.0 mass % of Cu, 0.01 to 0.75 mass % of Mn, and a balance that is Al and an inevitable impurity/impurities.

In such an aluminum alloy for casting, a content of Ni is 1.0 to 10.0 mass %, so that it is possible to crystallize a Ni-based intermetallic compound phase that is an intermetallic compound phase with an elongated shape that is originated from Ni, dispersedly, in an aluminum alloy. Hence, it is possible to improve a stiffness of an aluminum alloy. Moreover, a content of Cu is 8.01 to 18.0 mass %, so that it is possible to crystallize a Cu-based intermetallic compound phase that is an intermetallic compound phase that is originated from Cu, in a netlike shape, around a Ni-based intermetallic compound phase. Hence, a Ni-based intermetallic compound phase and a Cu-based intermetallic compound phase where crystallization regions thereof are different coexist, so that it is possible to further improve a stiffness of an aluminum alloy. Furthermore, a Cu-based intermetallic compound phase forms a network with a netlike shape around a Ni-based intermetallic compound phase, so that it is possible to improve a tensile strength of an aluminum alloy. Moreover, a lower limit of a content of Mn is 0.01 mass %, so that it is possible to crystallize a Mn-based intermetallic compound phase that is an intermetallic compound phase that is originated from Mn, in an aluminum alloy. Hence, a stiffness of an aluminum alloy is readily improved. Furthermore, an upper limit of a content of Mn is 0.75 mass %, so that coarsening of a Mn-based intermetallic compound phase as a hard phase is readily reduced or prevented so as to reduce or prevent embrittlement of an aluminum alloy. Hence, a decrease of a tensile strength of an aluminum alloy is readily reduced or prevented.

An aluminum alloy for casting may include 1.0 to 10.0 mass % of Ni, 8.01 to 18.0 mass % of Cu, 0.01 to 0.80 mass % of Fe, and a balance that is Al and an inevitable impurity/impurities.

In such an aluminum alloy for casting, a content of Ni is 1.0 to 10.0 mass %, so that it is possible to crystallize a Ni-based intermetallic compound phase, dispersedly, in an aluminum alloy. Hence, it is possible to improve a stiffness of an aluminum alloy. Moreover, a content of Cu is 8.01 to 18.0 mass %, so that it is possible to crystallize a Cu-based intermetallic compound phase, in a netlike shape, around a Ni-based intermetallic compound phase. Hence, a Ni-based intermetallic compound phase and a Cu-based intermetallic compound phase where crystallization regions thereof are different coexist, so that it is possible to further improve a stiffness of an aluminum alloy. Furthermore, a Cu-based intermetallic compound phase forms a network with a netlike shape around a Ni-based intermetallic compound phase, so that it is possible to improve a tensile strength of an aluminum alloy. Moreover, a lower limit of a content of Fe is 0.01 mass %, so that it is possible to crystallize an Fe-based intermetallic compound phase that is an intermetallic compound phase that is originated from Fe, in an aluminum alloy. Hence, a stiffness of an aluminum alloy is readily improved. Furthermore, an upper limit of a content of Fe is 0.80 mass %, so that coarsening of an Fe-based intermetallic compound phase as a hard phase is readily reduced or prevented so as to reduce or prevent embrittlement of an aluminum alloy. Hence, a decrease of a tensile strength of an aluminum alloy is readily reduced or prevented.

In an aluminum alloy for casting as described above, it is preferable that a content of Ni is 3.0 to 10.0 mass %. A lower limit of a content of Ni is 3.0 mass %, so that it is possible to crystallize a Ni-based intermetallic compound phase, more dispersedly, in an aluminum alloy. Hence, it is possible to further improve a stiffness of an aluminum alloy.

In an aluminum alloy for casting as described above, it is preferable that a content [Cu] of Cu and a content [Ni] of Ni satisfy a following condition (1).

$$10. \leq [ Cu ] + 0.87 [ Ni ] \leq 23.5 \qquad ( 1 )$$

It is preferable that an aluminum alloy for casting as described above further includes 5.0 to 20.0 mass % of Si. A content of Si is 5.0 to 20.0 mass %, so that it is possible to crystallize a Si-phase dispersedly in an aluminum alloy. Hence, it is possible to improve a stiffness of an aluminum alloy. Moreover, a content of Ni is 1.0 to 10.0 mass %, so that it is possible to crystallize a Ni-based intermetallic compound phase around a Si-phase. Moreover, a content of Cu is 8.01 to 18.0 mass %, so that it is possible to crystallize a Cu-based intermetallic compound phase, in a netlike shape, around a Si-phase and a Ni-based intermetallic compound phase. Hence, a Si-phase, a Ni-based intermetallic compound phase and a Cu-based intermetallic compound phase where crystallization regions thereof are different coexist, so that it is possible to further improve a stiffness of an aluminum alloy.

In an aluminum alloy for casting as described above, it is preferable that a content of Si is 5.0 to 14.5 mass %. An upper limit of a content of Si is 14.5 mass %, so that coarsening of a Si-phase in a solidification process of an aluminum alloy is readily reduced or prevented so as to reduce or prevent embrittlement of such an aluminum alloy. Hence, a tensile strength of an aluminum alloy is readily improved.

In an aluminum alloy for casting as described above, it is preferable that a content [Si] of Si, a content [Cu] of Cu and a content [Ni] of Ni satisfy a following condition (2).

$$30. \leq [ Si ] + 0.94 [ Cu ] + 2.02 [ Ni ] \leq 42.5 \qquad ( 2 )$$

It is preferable that an aluminum alloy for casting as described above further includes 0.0001 to 0.1 mass % of P. A content of P is 0.0001 to 0.1 mass %, so that AlP (aluminum phosphide) that is produced in an aluminum alloy acts as a heterogeneous nucleus for a primary crystal of Si, and hence, it is possible to miniaturize such a primary crystal of Si. Hence, a primary crystal of Si is readily crystallized uniformly and dispersedly in an aluminum alloy. Therefore, variations of a stiffness and a tensile strength of an aluminum alloy are readily reduced or prevented.

It is preferable that an aluminum alloy for casting as described above further includes 0.01 to 3.0 mass % of Mg. A content of Mg is 0.01 to 3.0 mass %, so that it is possible to precipitate a Mg-based intermetallic compound phase that is an intermetallic compound phase that is originated from Mg, by an aging process. Hence, it is possible to further improve a tensile strength of an aluminum alloy.

In an aluminum alloy for casting as described above, it is preferable that a content of Cu is 9.0 to 15.5 mass %.

Another aspect of the present invention is an aluminum casting that is provided by using and casting an aluminum alloy for casting as described above. It is possible to provide an aluminum casting that is high in a stiffness thereof and is also excellent in a tensile strength thereof.

Another aspect of the present invention is an aluminum alloy powder for lamination formation that includes 1.0 to 10.0 mass % of Ni, 8.01 to 18.0 mass % of Cu, 0.01 to 0.75 mass % of Mn, and a balance that is Al and an inevitable impurity/impurities. An aluminum alloy powder for lamination formation may include 1.0 to 10.0 mass % of Ni, 8.01 to 18.0 mass % of Cu, 0.01 to 0.80 mass % of Fe, and a balance that is Al and an inevitable impurity/impurities.

Another aspect of the present invention is a lamination formation product is lamination-formed by using an aluminum alloy powder for lamination formation as described above. It is possible to provide a lamination formation product that is high in a stiffness thereof and is also excellent in a tensile strength thereof.

### BRIEF DESCRIPTION OF DRAWINGS

FIG. 1 is a diagram that illustrates compositions, values of condition (1), values of condition (2), Young's moduli, and tensile strengths of practical examples and comparative examples of an aluminum alloy for casting according to an embodiment.

FIG. 2 is a diagram that illustrates a result of observation of a texture of a test piece of an aluminum alloy for casting according to comparative example 1.

FIG. 3 is a diagram that illustrates a result of observation of a texture of a test piece of an aluminum alloy for casting according to practical example 1.

FIG. 4 is a diagram that illustrates a result of observation of a texture of a test piece of an aluminum alloy for casting according to practical example 2.

FIG. 5 is a diagram that illustrates a result of observation of a texture of a test piece of an aluminum alloy for casting according to practical example 3.

FIG. 6 is a diagram that illustrates a result of observation of a texture of a test piece of an aluminum alloy for casting according to practical example 8.

FIG. 7 is a diagram that illustrates a result of observation of a texture of a test piece of an aluminum alloy for casting according to practical example 10.

FIG. 8 is a diagram that illustrates a result of observation of a texture of a test piece of an aluminum alloy for casting according to comparative example 2.

### DESCRIPTION OF EMBODIMENTS

Hereinafter, some embodiments where a composition (a content of a component element) of an aluminum alloy (that will be referred to as the “present composition” below) as disclosed in the present application is applicable thereto will be explained with reference to the accompanying drawing(s). An example of an embodiment where the present composition is applicable thereto is an aluminum alloy composition that has the present composition (that will be referred to as an “aluminum alloy composition” below). Furthermore, another example of an embodiment where the present composition is applicable thereto is an article that is manufactured by using an aluminum alloy composition (that will be referred to as the “present article” below).

For an embodiment of an aluminum alloy composition, for example, an aluminum alloy for casting, an aluminum alloy powder for lamination formation, a material for welding, a material for spraying, etc., are provided. For an embodiment of the present article, for example, an aluminum casting that is provided by using and casting an aluminum alloy for casting, a lamination formation product that is lamination-formed by using an aluminum alloy powder for lamination formation, a formation product that is formed by using a material for welding, a formation product that is formed by using a material for spraying, etc., are provided. Although a plurality of embodiments (a first embodiment to a fifteenth embodiment) of an aluminum alloy for casting will be explained below, it is also possible to apply respective compositions of such a plurality of embodiments to an aluminum alloy powder for lamination formation, a material for welding, and a material for spraying, etc. Additionally, the present invention is not limited to undermentioned embodiments (a first embodiment to a fifteenth embodiment).

### First Embodiment

An aluminum alloy for casting according to a first embodiment includes 1.0 to 10.0 mass % of Ni, 8.01 to 18.0 mass % of Cu, 0.01 to 0.75 mass % of Mn, and a balance that is Al and an inevitable impurity/impurities.

In the present embodiment, “casting” includes casting that is executed by various types of casting methods such as a sand mold casting method, a metallic mold casting method, and a die-casting method. Furthermore, an “aluminum alloy” means an alloy that includes an aluminum phase as a main phase thereof. Therefore, an “aluminum alloy for casting” means an aluminum alloy that is casted by various types of casting methods such as a sand mold casting method, a metallic mold casting method, and a die-casting method. A “mass %” of an element means a percentage of a mass of such an element in a mass of an aluminum alloy for casting. For example, a representation of “A to B mass % of an element” means that a mass % of an element is A % or more and B % or less. A “balance” means a component(s) other than a listed element(s), among components that compose an aluminum alloy for casting. For example, a representation of “An aluminum alloy for casting that includes . . . Ni, . . . Cu, . . . Mn, and a balance that is Al and an inevitable impurity/impurities.” means that components other than Ni, Cu, and Mn, among components that compose an aluminum alloy for casting, are Al and an inevitable impurity/impurities. The same also applies to an undermentioned embodiment(s).

### (Ni: Nickel)

An aluminum alloy for casting according to the first embodiment includes 1.0 to 10.0 mass % of Ni. In an aluminum alloy for casting according to the present embodiment, a Ni-based intermetallic compound phase that is an intermetallic compound phase with an elongated shape that is originated from Ni is dispersedly crystallized as, for example, a primary crystal, in an aluminum alloy. A lower limit of a content of Ni is 1.0 mass %, so that it is possible to increase an amount of a produced Ni-based intermetallic compound phase. Hence, it is possible to improve a stiffness of an aluminum alloy. Furthermore, an upper limit of a content of Ni is 10.0 mass %, so that it is possible to reduce or prevent coarsening of a Ni-based intermetallic compound phase in a solidification process of an aluminum alloy. Hence, for example, a situation where a crack develops along a Ni-based intermetallic compound phase with an elongated shape is also readily reduced or prevented preliminarily. Therefore, it is possible to reduce or prevent a decrease of a tensile strength of an aluminum alloy. The same also applies to an undermentioned embodiment(s).

### (Cu: Copper)

An aluminum alloy for casting according to the first embodiment includes 8.01 to 18.0 mass % of Cu. In an aluminum alloy for casting according to the present embodiment, a Cu-based intermetallic compound phase that is an intermetallic compound phase that is originated from Cu is crystallized in a netlike shape as, for example, a eutectic crystal with Al, around a Ni-based intermetallic compound phase. A lower limit of a content of Cu is 8.01 mass %, so that it is possible to increase an amount of a produced Cu-based intermetallic compound phase. Hence, it is possible to improve a stiffness of an aluminum alloy. Furthermore, an upper limit of a content of Cu is 18.0 mass %, so that it is possible to reduce or prevent an excessive increase of a Cu-based intermetallic compound phase as a hard phase. Hence, it is possible to reduce or prevent embrittlement of an aluminum alloy. Therefore, it is possible to reduce or prevent a decrease of a tensile strength of an aluminum alloy. The same also applies to an undermentioned embodiment(s).

### (Mn: Manganese)

An aluminum alloy for casting according to the first embodiment includes 0.01 to 0.75 mass % of Mn. A lower limit of a content of Mn is 0.01 mass %, so that it is possible to crystallize a Mn-based intermetallic compound phase that is an intermetallic compound phase that is originated from Mn, in an aluminum alloy. Hence, it is possible to improve a stiffness of an aluminum alloy. Moreover, a lower limit of a content of Mn is 0.01 mass %, so that it is possible to improve a strength of an aluminum casting at a high temperature. Moreover, a lower limit of a content of Mn is 0.01 mass %, so that it is possible to reduce or prevent a decrease of a corrosion resistance of an aluminum casting that is caused by Cu. Furthermore, an upper limit of a content of Mn is 0.75 mass %, so that it is possible to reduce or prevent coarsening of a Mn-based intermetallic compound phase as a hard phase. Hence, it is possible to reduce or prevent embrittlement of an aluminum alloy. Therefore, it is possible to reduce or prevent a decrease of a tensile strength of an aluminum alloy. Moreover, an upper limit of a content of Mn is 0.75 mass %, so that it is possible to reduce or prevent production of a sludge at a time of casting for an aluminum casting. Hence, it is possible to reduce or prevent occurrence of a casting defect such as a hard spot. Moreover, an upper limit of a content of Mn is 0.75 mass %, so that it is possible to reduce or prevent a decrease of an electrical conductivity of an aluminum casting. The same also applies to an undermentioned embodiment(s).

### (Al: Aluminum, Inevitable Impurity/Impurities)

A balance in an aluminum alloy for casting according to the first embodiment is Al and an inevitable impurity/impurities. In the present embodiment, “an inevitable impurity/impurities” does/do not mean an intentionally added element(s) but means an element(s) that is/are inevitably incorporated in a used raw material(s), a manufacturing step(s), etc. In the present embodiment and an undermentioned embodiment(s), for an inevitable impurity/impurities, an element(s) other than elements that are listed in each embodiment is/are provided where, for example, an element(s) such as Zn (zinc), Sn (tin), and/or Pb (lead) is/are provided. It is preferable that a content(s) of an inevitable impurity/impurities is/are 7.5 mass % or less in total, and it is more preferable that it/they is/are 5.0 mass % or less in total, 4.0 mass % or less in total, or 3.0 mass % or less in total. The same also applies to an undermentioned embodiment(s).

In an aluminum alloy for casting according to the present embodiment, a content of Ni is 1.0 to 10.0 mass %, so that it is possible to crystallize a Ni-based intermetallic compound phase dispersedly in an aluminum alloy. Hence, it is possible to improve a stiffness of an aluminum alloy. Moreover, a content of Cu is 8.01 to 18.0 mass %, so that it is possible to crystallize a Cu-based intermetallic compound phase in a netlike shape around a Ni-based intermetallic compound phase. Hence, a Ni-based intermetallic compound phase and a Cu-based intermetallic compound phase where crystallization regions thereof are different coexist, so that it is possible to further improve a stiffness of an aluminum alloy. Furthermore, a Cu-based intermetallic compound phase forms a network with a netlike shape around a Ni-based intermetallic compound phase, so that it is possible to improve a tensile strength of an aluminum alloy. Moreover, a lower limit of a content of Mn is 0.01 mass %, so that it is possible to crystallize a Mn-based intermetallic compound phase in an aluminum alloy. Hence, it is possible to improve a stiffness of an aluminum alloy. Furthermore, an upper limit of a content of Mn is 0.75 mass %, so that it is possible to reduce or prevent coarsening of a Mn-based intermetallic compound phase as a hard phase so as to reduce or prevent embrittlement of an aluminum alloy. Hence, it is possible to reduce or prevent a decrease of a tensile strength of an aluminum alloy.

In an aluminum alloy for casting according to the present embodiment, it is preferable that a lower limit of a content of Ni is 1.5 mass %, and it is more preferable that it is 2.0 mass %, 2.1 mass %, 3.0 mass %, 3.5 mass %, or 4.0 mass %. Furthermore, it is preferable that an upper limit of a content of Ni is 8.0 mass %, and it is more preferable that it is 7.0 mass %, 6.5 mass %, or 6.1 mass %. A lower limit and an upper limit of a content of Ni are thus provided, so that both a stiffness and a tensile strength of an aluminum alloy are readily improved. Alternatively, a situation where one of a stiffness and a tensile strength thereof is extremely decreased is reduced or prevented, so that both a stiffness and a tensile strength thereof are readily developed with balance. In particular, a lower limit of a content of Ni is 3.0 mass %, so that it is possible to crystallize a Ni-based intermetallic compound phase more dispersedly in an aluminum alloy. Hence, it is possible to further improve a stiffness of an aluminum alloy. The same also applies to an undermentioned embodiment(s).

In an aluminum alloy for casting according to the present embodiment, it is preferable that a lower limit of a content of Cu is 8.2 mass %, and it is more preferable that it is 9.0 mass %, 9.5 mass %, 10.0 mass %, 10.1 mass %, 10.5 mass %, 11.0 mass %, 11.5 mass %, or 11.9 mass %. Furthermore, it is preferable that an upper limit of a content of Cu is 17.5 mass %, and it is more preferable that it is 17.0 mass %, 16.5 mass %, 16.0 mass %, 15.5 mass %, 15.0 mass %, or 14.7 mass %. A lower limit and an upper limit of a content of Cu are thus provided, so that both a stiffness and a tensile strength of an aluminum alloy are readily improved. Alternatively, a situation where one of a stiffness and a tensile strength thereof is extremely decreased is readily reduced or prevented so as to develop both a stiffness and a tensile strength thereof with balance. The same also applies to an undermentioned embodiment(s).

In an aluminum alloy for casting according to the present embodiment, it is preferable that a lower limit of a content of Mn is 0.05 mass %, and it is more preferable that it is 0.10 mass %, 0.15 mass %, 0.20 mass %, 0.25 mass %, or 0.30 mass %. Furthermore, it is preferable that an upper limit of a content of Mn is 0.70 mass %, and it is more preferable that it is 0.67 mass %, 0.65 mass %, 0.60 mass %, or 0.55 mass %. A lower limit and an upper limit of a content of Mn are thus provided, so that both a stiffness and a tensile strength of an aluminum alloy are readily improved. Alternatively, a situation where one of a stiffness and a tensile strength thereof is extremely decreased is readily reduced or prevented so as to develop both a stiffness and a tensile strength thereof with balance. The same also applies to an undermentioned embodiment(s).

In an aluminum alloy for casting according to the present embodiment, compounding thereof is executed in such a manner that a content [Cu] of Cu and a content [Ni] of Ni satisfy undermentioned condition (1).

$$10. \leq [ Cu ] + 0.87 [ Ni ] \leq 23.5 \qquad ( 1 )$$

In the present embodiment, condition (1) is satisfied, so that both a stiffness and a tensile strength of an aluminum alloy are readily improved. Alternatively, a situation where one of a stiffness and a tensile strength thereof is extremely decreased is readily reduced or prevented so as to develop both a stiffness and a tensile strength thereof with balance. It is preferable that a lower limit of condition (1) is 11.0, and it is more preferable that it is 12.0 or 13.0. Furthermore, it is preferable that an upper limit of condition (1) is 23.0, and it is more preferable that it is 22.5. The same also applies to an undermentioned embodiment(s).

### Second Embodiment

An aluminum alloy for casting according to a second embodiment includes 1.0 to 10.0 mass % of Ni, 8.01 to 18.0 mass % of Cu, 0.01 to 0.75 mass % of Mn, 5.0 to 20.0 mass % of Si, and a balance that is Al and an inevitable impurity/impurities.

### (Si: Silicon)

An aluminum alloy for casting according to the second embodiment includes 5.0 to 20.0 mass % of Si. In an aluminum alloy for casting according to the present embodiment, a Si phase is dispersedly crystallized as, for example, each of a primary crystal of Si and a eutectic crystal of Si with Al. A lower limit of a content of Si is 5.0 mass %, so that it is possible to increase an amount of a crystallized Si phase. Hence, it is possible to improve a stiffness of an aluminum alloy. Furthermore, an upper limit of a content of Si is 20.0 mass %, so that it is possible to reduce or prevent coarsening of a Si phase in a solidification process of an aluminum alloy. Hence, it is possible to reduce or prevent embrittlement of an aluminum alloy. Therefore, it is possible to reduce or prevent a decrease of a tensile strength of an aluminum alloy. Moreover, an upper limit of a content of Si is 20.0 mass %, so that it is possible to reduce or prevent an increase of buoyancy that acts on a Si phase in association with coarsening of such a Si phase. Hence, it is possible to reduce or prevent floating and/or separation of a Si phase in an aluminum alloy. Therefore, it is possible to reduce or prevent variations of a texture and a tensile strength of an aluminum alloy. The same also applies to an undermentioned embodiment(s).

In an aluminum alloy for casting according to the present embodiment, a content of Si is 5.0 to 20.0 mass %, so that it is possible to crystallize a Si phase as a primary crystal and a eutectic crystal dispersedly in an aluminum alloy. Hence, it is possible to improve a stiffness of an aluminum alloy. Moreover, a content of Ni is 1.0 to 10.0 mass %, so that it is possible to crystallize a Ni-based intermetallic compound phase around a Si phase. Moreover, a content of Cu is 8.01 to 18.0 mass %, so that it is possible to crystallize a Cu-based intermetallic compound phase in a netlike shape around a Si phase and a Ni-based intermetallic compound phase. Hence, a Si phase, a Ni-based intermetallic compound phase, and a Cu-based intermetallic compound phase where crystallization regions thereof are different coexist, so that it is possible to further improve a stiffness of an aluminum alloy. Moreover, a content of Mn is 0.01 to 0.75 mass %, so that it is possible to improve a stiffness of an aluminum alloy and it is possible to reduce or prevent a decrease of a tensile strength thereof.

In an aluminum alloy for casting according to the present embodiment, it is preferable that a lower limit of a content of Si is 5.5 mass %, and it is more preferable that it is 5.6 mass %, 6.0 mass %, 6.5 mass %, 7.0 mass %, 7.5 mass %, 8.0 mass %, or 8.5 mass %. Furthermore, it is preferable that an upper limit of a content of Si is 18.0 mass %, and it is more preferable that it is 17.0 mass %, 16.5 mass %, 16.4 mass %, 16.0 mass %, 15.5 mass %, 15.0 mass %, 14.5 mass %, 14.0 mass %, 13.8 mass %, or 13.5 mass %. A lower limit and an upper limit of a content of Si are thus provided, so that both a stiffness and a tensile strength of an aluminum alloy are readily improved. Alternatively, a situation where one of a stiffness and a tensile strength thereof is extremely decreased is readily reduced or prevented so as to develop both a stiffness and a tensile strength thereof with balance. In particular, an upper limit of a content of Si is 14.5 mass %, so that coarsening of a Si phase in a solidification process of an aluminum alloy is readily reduced or prevented so as to further reduce or prevent embrittlement of an aluminum alloy. Hence, a tensile strength of an aluminum alloy is readily improved. The same also applies to an undermentioned embodiment(s).

In an aluminum alloy for casting according to the present embodiment, compounding thereof is executed in such a manner that a content [Si] of Si, a content [Cu] of Cu and a content [Ni] of Ni satisfy undermentioned condition (2).

$$30. \leq [ Si ] + 0.94 [ Cu ] + 2.02 [ Ni ] \leq 42.5 \qquad ( 2 )$$

In the present embodiment, condition (2) is satisfied, so that both a stiffness and a tensile strength of an aluminum alloy are readily improved. Alternatively, a situation where one of a stiffness and a tensile strength thereof is extremely decreased is readily reduced or prevented so as to develop both a stiffness and a tensile strength thereof with balance. It is preferable that a lower limit of condition (2) is 30.5, and it is more preferable that it is 31.0 or 31.5. Furthermore, it is preferable that an upper limit of condition (2) is 42.0, and it is more preferable that it is 41.5. The same also applies to an undermentioned embodiment(s).

### Third Embodiment

An aluminum alloy for casting according to a third embodiment includes 1.0 to 10.0 mass % of Ni, 8.01 to 18.0 mass % of Cu, 0.01 to 0.75 mass % of Mn, 5.0 to 20.0 mass % of Si, 0.0001 to 0.1 mass % of P, and a balance that is Al and an inevitable impurity/impurities.

### (P: Phosphorus)

An aluminum alloy for casting according to the third embodiment includes 0.0001 to 0.1 mass % of P. A lower limit of a content of P is 0.0001 mass %, so that it is possible to improve an action to miniaturize a primary crystal of Si. Hence, it is possible to crystallize a primary crystal of Si uniformly and dispersedly in an aluminum alloy. Furthermore, an upper limit of a content of P is 0.1 mass %, so that it is possible to reduce or prevent a decrease of a fluidity of an aluminum alloy. Therefore, it is possible to improve a casting property of an aluminum alloy. The same also applies to an undermentioned embodiment(s).

In an aluminum alloy for casting according to the present embodiment, a content of P is 0.0001 to 0.1 mass %, so that AlP (aluminum phosphide) that is produced in an aluminum alloy acts as a heterogeneous nucleus for a primary crystal of Si, and hence, it is possible to miniaturize such a primary crystal of Si. Hence, a primary crystal of Si is readily crystallized uniformly and dispersedly in an aluminum alloy. Therefore, variations of a stiffness and a tensile strength of an aluminum alloy are readily reduced or prevented.

In an aluminum alloy for casting according to the present embodiment, it is preferable that a lower limit of a content of P is 0.0003 mass %, and it is more preferable that it is 0.0006 mass %. Furthermore, it is preferable that an upper limit of a content of P is 0.05 mass %, and it is more preferable that it is 0.04 mass % or 0.03 mass %. A lower limit and an upper limit of a content of P are thus provided, so that variations of a stiffness and a tensile strength of an aluminum alloy are readily reduced or prevented. The same also applies to an undermentioned embodiment(s).

### Fourth Embodiment

An aluminum alloy for casting according to a fourth embodiment includes 1.0 to 10.0 mass % of Ni, 8.01 to 18.0 mass % of Cu, 0.01 to 0.75 mass % of Mn, 0.01 to 3.0 mass % of Mg, and a balance that is Al and an inevitable impurity/impurities.

### (Mg: Magnesium)

An aluminum alloy for casting according to the fourth embodiment includes 0.01 to 3.0 mass % of Mg. A lower limit of a content of Mg is 0.01 mass %, so that it is possible to improve an action to precipitate a Mg-based intermetallic compound phase that is an intermetallic compound phase that is originated from Mg, by an aging process for an aluminum alloy. Hence, it is possible to attain precipitation strengthening for an aluminum alloy. Furthermore, an upper limit of a content of Mg is 3.0 mass %, so that it is possible to reduce or prevent an excessive increase of a Mg-based intermetallic compound phase. Hence, it is possible to reduce or prevent a decrease of elongation of an aluminum alloy. The same also applies to an undermentioned embodiment(s).

In an aluminum alloy for casting according to the present embodiment, a content of Mg is 0.01 to 3.0 mass %, so that it is possible to precipitate a Mg-based intermetallic compound phase that is an intermetallic compound phase that is originated from Mg, by an aging process. Hence, it is possible to further improve a tensile strength of an aluminum alloy.

In an aluminum alloy for casting according to the present embodiment, it is preferable that a lower limit of a content of Mg is 0.05 mass %, and it is more preferable that it is 0.1 mass %, 0.2 mass %, or 0.3 mass %. Furthermore, it is preferable that an upper limit of a content of Mg is 2.5 mass %, and it is more preferable that it is 2.0 mass %, 1.9 mass %, 1.8 mass %, 1.5 mass %, 1.0 mass %, 0.8 mass %, or 0.6 mass %. A lower limit and an upper limit of a content of Mg are thus provided, so that a tensile strength of an aluminum alloy is readily improved. The same also applies to an undermentioned embodiment(s).

An aluminum alloy for casting according to the present embodiment may further include 5.0 to 20.0 mass % of Si. Furthermore, an aluminum alloy for casting according to the present embodiment may further include 0.0001 to 0.1 mass % of P.

### Fifth Embodiment

An aluminum alloy for casting according to a fifth embodiment includes 1.0 to 10.0 mass % of Ni, 8.01 to 18.0 mass % of Cu, 0.01 to 0.75 mass % of Mn, 0.01 to 0.80 mass % of Fe, and a balance that is Al and an inevitable impurity/impurities.

### (Fe: Iron)

An aluminum alloy for casting according to the fifth embodiment includes 0.01 to 0.80 mass % of Fe. A lower limit of a content of Fe is 0.01 mass %, so that it is possible to crystallize a Fe-based intermetallic compound phase that is an intermetallic compound phase that is originated from Fe, in an aluminum alloy. Hence, it is possible to improve a stiffness of an aluminum alloy. Moreover, a lower limit of a content of Fe is 0.01 mass %, so that it is possible to reduce or prevent occurrence of galling of an aluminum alloy in a case where casting for an aluminum casting is executed by a die-casting method. Furthermore, an upper limit of a content of Fe is 0.80 mass %, so that it is possible to reduce or prevent coarsening of a Fe-based intermetallic compound phase as a hard phase. Hence, it is possible to reduce or prevent embrittlement of an aluminum alloy. Therefore, it is possible to reduce or prevent a decrease of a tensile strength of an aluminum alloy. Moreover, an upper limit of a content of Fe is 0.80 mass %, so that it is possible to reduce or prevent a decrease of a corrosion resistance of an aluminum casting. Moreover, an upper limit of a content of Fe is 0.80 mass %, so that it is possible to reduce or prevent production of a sludge at a time of casting for an aluminum casting. Hence, it is possible to reduce or prevent occurrence of a casting defect such as a hard spot. The same also applies to an undermentioned embodiment(s).

In an aluminum alloy for casting according to the present embodiment, a content of Fe is 0.01 to 0.80 mass %, so that it is possible to improve a stiffness of an aluminum alloy and reduce or prevent a decrease of a tensile strength thereof. Moreover, a content of Mn is 0.01 to 0.75 mass %, so that it is possible to reduce or prevent a decrease of a corrosion resistance of an aluminum casting that is caused by Fe.

In an aluminum alloy for casting according to the present embodiment, it is preferable that a lower limit of a content of Fe is 0.05 mass %, and it is more preferable that it is 0.10 mass %, 0.15 mass %, 0.20 mass %, 0.25 mass %, 0.29 mass %, 0.30 mass %, 0.31 mass %, 0.32 mass %, or 0.34 mass %. Furthermore, it is preferable that an upper limit of a content of Fe is 0.75 mass %, and it is more preferable that it is 0.70 mass %, 0.65 mass %, 0.60 mass %, or 0.55 mass %. A lower limit and an upper limit of a content of Fe are thus provided, so that both a stiffness and a tensile strength of an aluminum alloy are readily improved. Alternatively, a situation where one of a stiffness and a tensile strength thereof is extremely decreased is reduced or prevented, so that both a stiffness and a tensile strength thereof are readily developed with balance. The same also applies to an undermentioned embodiment(s).

An aluminum alloy for casting according to the present embodiment may further include 5.0 to 20.0 mass % of Si. Furthermore, an aluminum alloy for casting according to the present embodiment may further include 0.0001 to 0.1 mass % of P. Furthermore, an aluminum alloy for casting according to the present embodiment may further include 0.01 to 3.0 mass % of Mg.

### Sixth Embodiment

An aluminum alloy for casting according to a sixth embodiment includes 1.0 to 10.0 mass % of Ni, 8.01 to 18.0 mass % of Cu, 0.01 to 0.75 mass % of Mn, 0.0001 to 0.50 mass % of Cr, and a balance that is Al and an inevitable impurity/impurities.

### (Cr: Chromium)

An aluminum alloy for casting according to the sixth embodiment includes 0.0001 to 0.50 mass % of Cr. A lower limit of a content of Cr is 0.0001 mass %, so that it is possible to improve a strength of an aluminum casting at a high temperature. Furthermore, an upper limit of a content of Cr is 0.50 mass %, so that it is possible to reduce or prevent coarsening of a Cr-based intermetallic compound phase that is an intermetallic compound phase that is originated from Cr. Hence, it is possible to reduce or prevent embrittlement of an aluminum alloy. Moreover, an upper limit of a content of Cr is 0.50 mass %, so that it is possible to reduce or prevent production of a sludge at a time of casting for an aluminum casting. Hence, it is possible to reduce or prevent occurrence of a casting defect such as a hard spot. Moreover, an upper limit of a content of Cr is 0.50 mass %, so that it is possible to reduce or prevent decreases of a thermal conductivity and an electrical conductivity of an aluminum casting. The same also applies to an undermentioned embodiment(s).

In an aluminum alloy for casting according to the present embodiment, it is preferable that a lower limit of a content of Cr is 0.001 mass %, and it is more preferable that it is 0.005 mass % or 0.01 mass %. Furthermore, it is preferable that an upper limit of a content of Cr is 0.30 mass %, and it is more preferable that it is 0.10 mass %, 0.07 mass %, 0.05 mass %, or 0.03 mass %. The same also applies to an undermentioned embodiment(s).

An aluminum alloy for casting according to the present embodiment may further include 5.0 to 20.0 mass % of Si. Furthermore, an aluminum alloy for casting according to the present embodiment may further include 0.0001 to 0.1 mass % of P. Furthermore, an aluminum alloy for casting according to the present embodiment may further include 0.01 to 3.0 mass % of Mg. Furthermore, an aluminum alloy for casting according to the present embodiment may further include 0.01 to 0.80 mass % of Fe.

### Seventh Embodiment

An aluminum alloy for casting according to a seventh embodiment includes 1.0 to 10.0 mass % of Ni, 8.01 to 18.0 mass % of Cu, 0.01 to 0.75 mass % of Mn, 0.0001 to 0.75 mass % of Ti, and a balance that is Al and an inevitable impurity/impurities.

### (Ti: Titanium)

An aluminum alloy for casting according to the seventh embodiment includes 0.0001 to 0.75 mass % of Ti. A lower limit of a content of Ti is 0.0001 mass %, so that a crystal grain in an aluminum alloy is readily miniaturized. Hence, occurrence of shrinkage porosity and/or thermal cracking in an aluminum casting is readily reduced so as to improve a heat resistance and/or a mechanical property thereof. Furthermore, an upper limit of a content of Ti is 0.75 mass %, so that it is possible to reduce or prevent coarsening of a Ti-based intermetallic compound phase that is an intermetallic compound phase that is originated from Ti. Hence, it is possible to reduce or prevent a decrease of a toughness of an aluminum alloy. Moreover, an upper limit of a content of Ti is 0.75 mass %, so that it is possible to reduce or prevent a decrease of an electrical conductivity of an aluminum casting. The same also applies to an undermentioned embodiment(s).

In an aluminum alloy for casting according to the present embodiment, it is preferable that a lower limit of a content of Ti is 0.001 mass %, and it is more preferable that it is 0.005 mass %, 0.01 mass %, 0.05 mass %, or 0.10 mass %. Furthermore, it is preferable that an upper limit of a content of Ti is 0.50 mass %, and it is more preferable that it is 0.30 mass % or 0.20 mass %. The same also applies to an undermentioned embodiment(s).

An aluminum alloy for casting according to the present embodiment may further include 5.0 to 20.0 mass % of Si. Furthermore, an aluminum alloy for casting according to the present embodiment may further include 0.0001 to 0.1 mass % of P. Furthermore, an aluminum alloy for casting according to the present embodiment may further include 0.01 to 3.0 mass % of Mg. Furthermore, an aluminum alloy for casting according to the present embodiment may further include 0.01 to 0.80 mass % of Fe. Furthermore, an aluminum alloy for casting according to the present embodiment may further include 0.0001 to 0.50 mass % of Cr.

### Eighth Embodiment

An aluminum alloy for casting according to an eighth embodiment includes 1.0 to 10.0 mass % of Ni, 8.01 to 18.0 mass % of Cu, 0.01 to 0.75 mass % of Mn, 0.0001 to 0.50 mass % of V, and a balance that is Al and an inevitable impurity/impurities.

### (V: Vanadium)

An aluminum alloy for casting according to the eighth embodiment includes 0.0001 to 0.50 mass % of V. A lower limit of a content of V is 0.0001 mass %, so that it is possible to improve a heat resistance of an aluminum casting. Furthermore, an upper limit of a content of V is 0.50 mass %, so that it is possible to reduce or prevent a decrease of an electrical conductivity of an aluminum casting. The same also applies to an undermentioned embodiment(s).

In an aluminum alloy for casting according to the present embodiment, it is preferable that a lower limit of a content of V is 0.001 mass %, and it is more preferable that it is 0.005 mass % or 0.01 mass %. Furthermore, it is preferable that an upper limit of a content of V is 0.30 mass %, and it is more preferable that it is 0.20 mass %, 0.10 mass %, or 0.07 mass %. The same also applies to an undermentioned embodiment(s).

An aluminum alloy for casting according to the present embodiment may further include 5.0 to 20.0 mass % of Si. Furthermore, an aluminum alloy for casting according to the present embodiment may further include 0.0001 to 0.1 mass % of P. Furthermore, an aluminum alloy for casting according to the present embodiment may further include 0.01 to 3.0 mass % of Mg. Furthermore, an aluminum alloy for casting according to the present embodiment may further include 0.01 to 0.80 mass % of Fe. Furthermore, an aluminum alloy for casting according to the present embodiment may further include 0.0001 to 0.50 mass % of Cr. Furthermore, an aluminum alloy for casting according to the present embodiment may further include 0.0001 to 0.75 mass % of Ti.

### Ninth Embodiment

An aluminum alloy for casting according to a ninth embodiment includes 1.0 to 10.0 mass % of Ni, 8.01 to 18.0 mass % of Cu, 0.01 to 0.80 mass % of Fe, and a balance that is Al and an inevitable impurity/impurities.

In an aluminum alloy for casting according to the present embodiment, a content of Ni is 1.0 to 10.0 mass %, so that it is possible to crystallize a Ni-based intermetallic compound phase dispersedly in an aluminum alloy. Hence, it is possible to improve a stiffness of an aluminum alloy. Moreover, a content of Cu is 8.01 to 18.0 mass %, so that it is possible to crystallize a Cu-based intermetallic compound phase in a netlike shape around a Ni-based intermetallic compound phase. Hence, a Ni-based intermetallic compound phase and a Cu-based intermetallic compound phase where crystallization regions thereof are different coexist, so that it is possible to further improve a stiffness of an aluminum alloy. Furthermore, a Cu-based intermetallic compound phase forms a network with a netlike shape around a Ni-based intermetallic compound phase, so that it is possible to improve a tensile strength of an aluminum alloy. Moreover, a lower limit of a content of Fe is 0.01 mass %, so that it is possible to crystallize a Fe-based intermetallic compound phase in an aluminum alloy. Hence, it is possible to improve a stiffness of an aluminum alloy. Furthermore, an upper limit of a content of Fe is 0.80 mass %, so that it is possible to reduce or prevent coarsening of a Fe-based intermetallic compound phase as a hard phase so as to reduce or prevent embrittlement of an aluminum alloy. Hence, it is possible to reduce or prevent a decrease of a tensile strength of an aluminum alloy.

### Tenth Embodiment

An aluminum alloy for casting according to a tenth embodiment includes 1.0 to 10.0 mass % of Ni, 8.01 to 18.0 mass % of Cu, 0.01 to 0.80 mass % of Fe, 5.0 to 20.0 mass % of Si, and a balance that is Al and an inevitable impurity/impurities.

In an aluminum alloy for casting according to the present embodiment, a content of Si is 5.0 to 20.0 mass %, so that it is possible to crystallize a Si phase as a primary crystal and a eutectic crystal dispersedly in an aluminum alloy. Hence, it is possible to improve a stiffness of an aluminum alloy. Moreover, a content of Ni is 1.0 to 10.0 mass %, so that it is possible to crystallize a Ni-based intermetallic compound phase around a Si phase. Moreover, a content of Cu is 8.01 to 18.0 mass %, so that it is possible to crystallize a Cu-based intermetallic compound phase in a netlike shape around a Si phase and a Ni-based intermetallic compound phase. Hence, a Si phase, a Ni-based intermetallic compound phase, and a Cu-based intermetallic compound phase where crystallization regions thereof are different coexist, so that it is possible to further improve a stiffness of an aluminum alloy. Moreover, a content of Fe is 0.01 to 0.80 mass %, so that it is possible to improve a stiffness of an aluminum alloy and reduce or prevent a decrease of a tensile strength thereof.

### Eleventh Embodiment

An aluminum alloy for casting according to an eleventh embodiment includes 1.0 to 10.0 mass % of Ni, 8.01 to 18.0 mass % of Cu, 0.01 to 0.80 mass % of Fe, 5.0 to 20.0 mass % of Si, 0.0001 to 0.1 mass % of P, and a balance that is Al and an inevitable impurity/impurities.

In an aluminum alloy for casting according to the present embodiment, a content of P is 0.0001 to 0.1 mass %, so that AlP (aluminum phosphide) that is produced in an aluminum alloy acts as a heterogeneous nucleus for a primary crystal of Si, and hence, it is possible to miniaturize such a primary crystal of Si. Hence, a primary crystal of Si is readily crystallized uniformly and dispersedly in an aluminum alloy. Therefore, variations of a stiffness and a tensile strength of an aluminum alloy are readily reduced or prevented.

### Twelfth Embodiment

An aluminum alloy for casting according to a twelfth embodiment includes 1.0 to 10.0 mass % of Ni, 8.01 to 18.0 mass % of Cu, 0.01 to 0.80 mass % of Fe, 0.01 to 3.0 mass % of Mg, and a balance that is Al and an inevitable impurity/impurities.

In an aluminum alloy for casting according to the present embodiment, a content of Mg is 0.01 to 3.0 mass %, so that it is possible to precipitate a Mg-based intermetallic compound phase that is an intermetallic compound phase that is originated from Mg, by an aging process. Hence, it is possible to further improve a tensile strength of an aluminum alloy.

An aluminum alloy for casting according to the present embodiment may further include 5.0 to 20.0 mass % of Si. Furthermore, an aluminum alloy for casting according to the present embodiment may further include 0.0001 to 0.1 mass % of P.

### Thirteenth Embodiment

An aluminum alloy for casting according to a thirteenth embodiment includes 1.0 to 10.0 mass % of Ni, 8.01 to 18.0 mass % of Cu, 0.01 to 0.80 mass % of Fe, 0.0001 to 0.50 mass % of Cr, and a balance that is Al and an inevitable impurity/impurities.

An aluminum alloy for casting according to the present embodiment may further include 5.0 to 20.0 mass % of Si. Furthermore, an aluminum alloy for casting according to the present embodiment may further include 0.0001 to 0.1 mass % of P. Furthermore, an aluminum alloy for casting according to the present embodiment may further include 0.01 to 3.0 mass % of Mg. Furthermore, an aluminum alloy for casting according to the present embodiment may further include 0.01 to 0.75 mass % of Mn.

### Fourteenth Embodiment

An aluminum alloy for casting according to a fourteenth embodiment includes 1.0 to 10.0 mass % of Ni, 8.01 to 18.0 mass % of Cu, 0.01 to 0.80 mass % of Fe, 0.0001 to 0.75 mass % of Ti, and a balance that is Al and an inevitable impurity/impurities.

An aluminum alloy for casting according to the present embodiment may further include 5.0 to 20.0 mass % of Si. Furthermore, an aluminum alloy for casting according to the present embodiment may further include 0.0001 to 0.1 mass % of P. Furthermore, an aluminum alloy for casting according to the present embodiment may further include 0.01 to 3.0 mass % of Mg. Furthermore, an aluminum alloy for casting according to the present embodiment may further include 0.01 to 0.75 mass % of Mn. Furthermore, an aluminum alloy for casting according to the present embodiment may further include 0.0001 to 0.50 mass % of Cr.

### Fifteenth Embodiment

An aluminum alloy for casting according to a fifteenth embodiment includes 1.0 to 10.0 mass % of Ni, 8.01 to 18.0 mass % of Cu, 0.01 to 0.80 mass % of Fe, 0.0001 to 0.50 mass % of V, and a balance that is Al and an inevitable impurity/impurities.

An aluminum alloy for casting according to the present embodiment may further include 5.0 to 20.0 mass % of Si. Furthermore, an aluminum alloy for casting according to the present embodiment may further include 0.0001 to 0.1 mass % of P. Furthermore, an aluminum alloy for casting according to the present embodiment may further include 0.01 to 3.0 mass % of Mg. Furthermore, an aluminum alloy for casting according to the present embodiment may further include 0.01 to 0.75 mass % of Mn. Furthermore, an aluminum alloy for casting according to the present embodiment may further include 0.0001 to 0.50 mass % of Cr. Furthermore, an aluminum alloy for casting according to the present embodiment may further include 0.0001 to 0.75 mass % of Ti.

An aluminum alloy for casting according to an aforementioned embodiment(s) is used, so that it is possible to provide an aluminum casting that is high in a stiffness thereof and is also excellent in a tensile strength thereof. Therefore, such an aluminum casting is preferable for a wide variety of applications that need a high stiffness and a high tensile strength thereof. For an example of an application of such an aluminum casting, a component(s), etc., of a machine tool, a robot, and an automobile, etc., is/are provided.

### Practical Examples

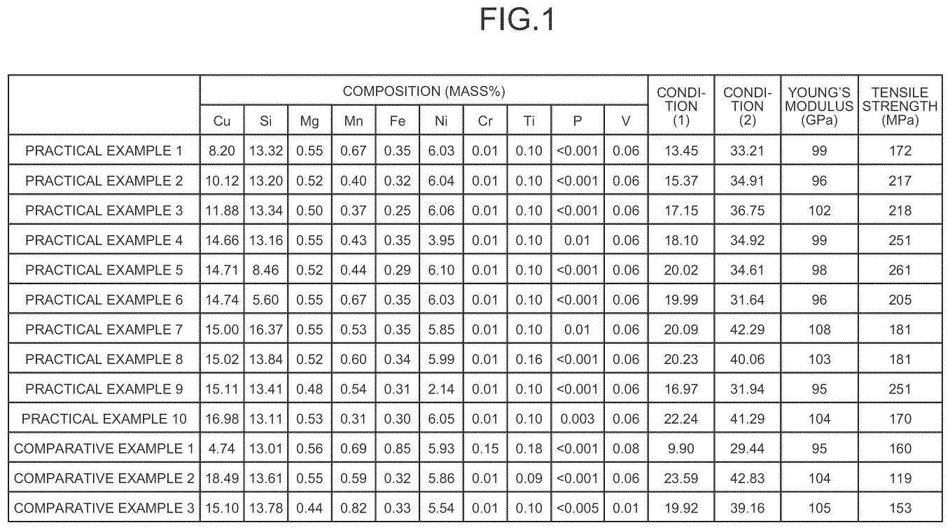

FIG. 1 illustrates compositions (mass %), values of condition (1), values of condition (2), Young's moduli (GPa), and tensile strengths (MPa) of some practical examples and comparative examples of an aluminum alloy for casting according to an aforementioned embodiment(s). In FIG. 1, a content (mass %) of each element is a value that was measured by using an ICP (inductively coupled plasma emission) spectrometer “iCAP 7400 ICP-OES” produced by Thermo Fisher Scientific Incorporated, according to an inductively coupled plasma emission spectrometry. Furthermore, a tensile strength (MPa) is a value that was measured for a test piece of an aluminum alloy for casting according to any of practical examples and comparative examples, according to “JIS Z 2241 (Metallic Material Tensile Test Method)”. For a test piece, a No. 14A test piece with a diameter of 6 mm and a parallel part length of 36 mm was used that was provided by casting according to a metallic mold casting method. Furthermore, a Young's modulus is a value that was obtained from a slope of a relationship between a strain and a stress within an elastic range in a tensile test. A strain is an average value of a measurement values of two uniaxial strain gauges that were oppositely applied on surfaces of parallel parts of a test piece.

### Comparison Between Practical Examples 1 to 10 and Comparative Example 1

As illustrated in FIG. 1, contents of Cu in practical examples 1 to 10 were 8.01 mass % or more whereas a content of Cu in comparative example 1 was less than 8.01 mass %. Furthermore, contents of Fe in practical examples 1 to 10 were 0.80 mass % or less whereas a content of Fe in comparative example 1 was more than 0.80 mass %. Herein, Young's moduli in practical examples 1 to 10 were 95 to 108 GPa whereas a Young's modulus in comparative example 1 was 95 GPa. Hence, stiffnesses in practical examples 1 to 10 were greater than that in comparative example 1 by about 14% at a maximum. Furthermore, tensile strengths in practical examples 1 to 10 were 170 to 261 MPa whereas a tensile strength in comparative example 1 was 160 MPa. Hence, tensile strengths in practical examples 1 to 10 were greater than that in comparative example 1 by about 63% at a maximum (even about 6% at a minimum). Thus, it could be confirmed that a lower limit of a content of Cu was 8.01 mass % and an upper limit of a content of Fe was 0.80 mass %, so that it was possible to improve a stiffness and a tensile strength of an aluminum alloy for casting.

### Comparison Between Practical Examples 1 to 10 and Comparative Example 2

As illustrated in FIG. 1, contents of Cu in practical examples 1 to 10 were 18.0 mass % or less whereas a content of Cu in comparative example 2 was more than 18.0 mass %. Herein, Young's moduli in practical examples 1 to 10 were 95 to 108 GPa whereas a Young's modulus in comparative example 2 was 104 GPa. Hence, a range of variation of stiffnesses in practical examples 1 to 10 fell within a range of 4 to 9% of that in comparative example 2. Furthermore, tensile strengths in practical examples 1 to 10 were 170 to 261 MPa whereas a tensile strength in comparative example 2 was 119 MPa. Hence, tensile strengths in practical examples 1 to 10 were greater than that in comparative example 2 by about 120% at a maximum (even about 43% at a minimum). Thus, it could be confirmed that an upper limit of a content of Cu was 18.0 mass %, so that it was possible to reduce or prevent a variation of a stiffness of an aluminum alloy for casting so as to develop such a stiffness stably, and improve a tensile strength thereof significantly.

### Comparison Between Practical Examples 1 to 10 and Comparative Example 3

As illustrated in FIG. 1, contents of Mn in practical examples 1 to 10 were 0.75 mass % or less whereas a content of Mn in comparative example 3 was more than 0.75 mass %. Herein, Young's moduli in practical examples 1 to 10 were 95 to 108 GPa whereas a Young's modulus in comparative example 3 was 105 GPa. Hence, a range of variation of stiffnesses in practical examples 1 to 10 fell within a range of 3 to 10% of that in comparative example 3. Furthermore, tensile strengths in practical examples 1 to 10 were 170 to 261 MPa whereas a tensile strength in comparative example 3 was 153 MPa. Hence, tensile strengths in practical examples 1 to 10 were greater than that in comparative example 3 by about 71% at a maximum (even about 11% at a minimum). Thus, it could be confirmed that an upper limit of a content of Mn was 0.75 mass %, so that it was possible to reduce or prevent a variation of a stiffness of an aluminum alloy for casting so as to develop such a stiffness stably, and improve a tensile strength thereof significantly.

### Comparison Between Practical Examples 2 to 9 and Practical Example 1

As illustrated in FIG. 1, contents of Cu in practical examples 2 to 9 were 9.0 mass % or more whereas a content of Cu in practical example 1 was less than 9.0 mass %. Herein, Young's moduli in practical examples 2 to 9 were 95 to 108 GPa whereas a Young's modulus in practical example 1 was 99 GPa. Hence, a range of variation of stiffnesses in practical examples 2 to 9 fell within a range of 4 to 9% of that in practical example 1. Furthermore, tensile strengths in practical examples 2 to 9 were 181 to 261 MPa whereas a tensile strength in practical example 1 was 172 MPa. Hence, tensile strengths in practical examples 2 to 9 were greater than that in practical example 1 by about 52% at a maximum (even about 5% at a minimum). Thus, it could be confirmed that a lower limit of a content of Cu was 9.0 mass %, so that it was possible to reduce or prevent a variation of a stiffness of an aluminum alloy for casting so as to develop such a stiffness stably, and improve a tensile strength thereof.

### Comparison Between Practical Examples 2 to 9 and Practical Example 10

As illustrated in FIG. 1, contents of Cu in practical examples 2 to 9 were 15.5 mass % or less whereas a content of Cu in practical example 10 was more than 15.5 mass %. Herein, Young's moduli in practical examples 2 to 9 were 95 to 108 GPa whereas a Young's modulus in practical example 10 was 104 GPa. Hence, a range of variation of stiffnesses in practical examples 2 to 9 fell within a range of 4 to 9% of that in practical example 10. Furthermore, tensile strengths in practical examples 2 to 9 were 181 to 261 MPa whereas a tensile strength in practical example 10 was 170 MPa. Hence, tensile strengths in practical examples 2 to 9 were greater than that in practical example 10 by about 54% at a maximum (even about 6% at a minimum). Thus, it could be confirmed that an upper limit of a content of Cu was 15.5 mass %, so that it was possible to reduce or prevent a variation of a stiffness of an aluminum alloy for casting so as to develop such a stiffness stably, and improve a tensile strength thereof.

### (Textures of Aluminum Alloys for Casting)

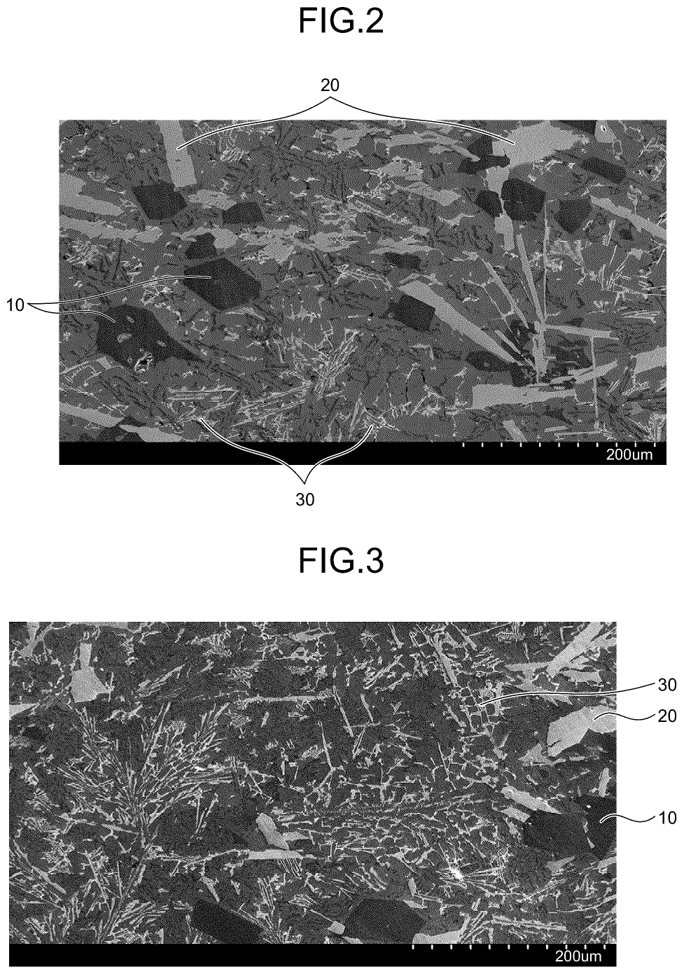

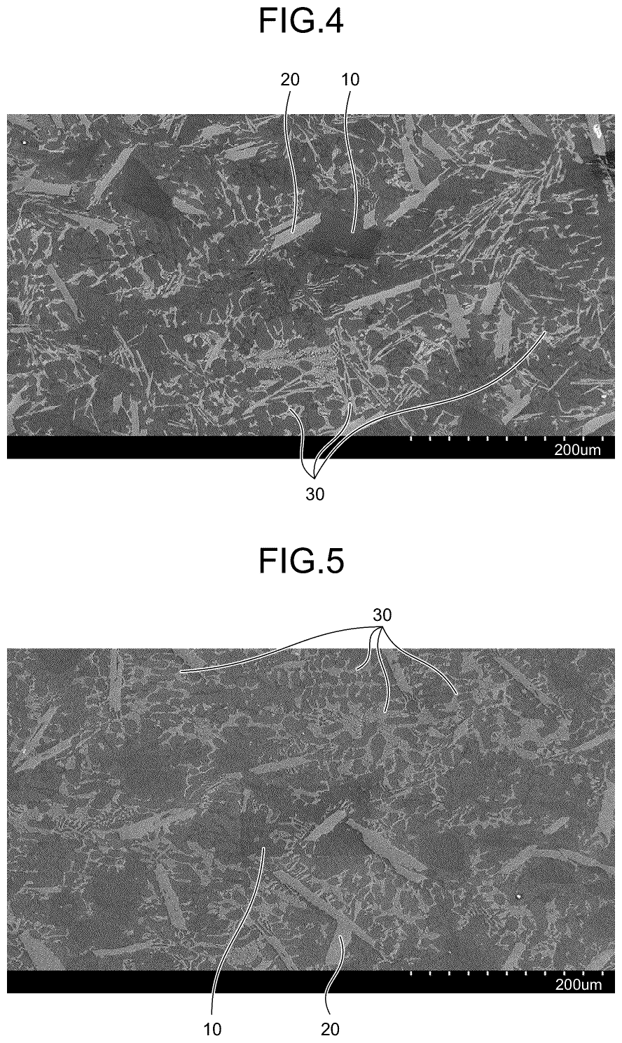

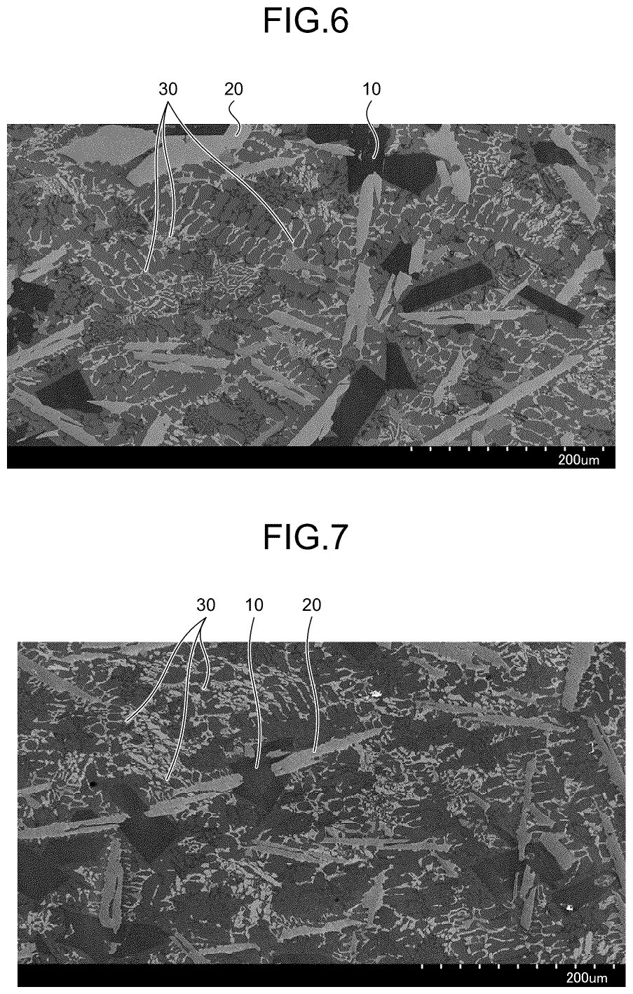

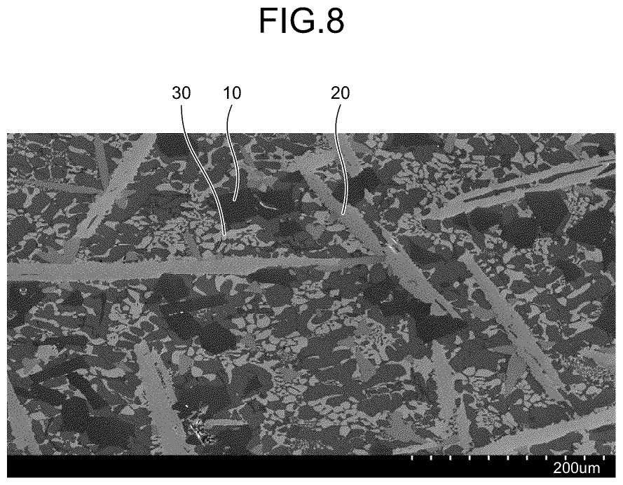

FIG. 2 to FIG. 8 illustrate results of observation on textures of test pieces of an aluminum alloys for casting. FIG. 2, FIG. 3, FIG. 4, FIG. 5, FIG. 6, FIG. 7, and FIG. 8 are diagrams that illustrate results of observation on microscopic textures of comparative example 1, practical example 1, practical example 2, practical example 3, practical example 8, practical example 10, and comparative example 2, respectively, by a scanning electron microscope (SEM).

As illustrated in FIG. 1, a content of Cu in comparative example 1 was 4.74 mass %. As illustrated in FIG. 2, in comparative example 1, a Cu-based intermetallic compound phase 30 with a thin needle shape was crystallized sparsely around a Si phase 10 and a Ni-based intermetallic compound phase 20 that were crystallized in an aluminum alloy. Furthermore, in comparative example 1, a lot of parts where a Cu-based intermetallic compound phase 30 was not crystallized existed in an aluminum alloy, and even parts where a Cu-based intermetallic compound phase 30 was crystallized were distributed discontinuously in a state where adjacent Cu-based intermetallic compound phases 30 are separated from one another. As a result, as illustrated in FIG. 1, it was difficult to improve a tensile strength of an aluminum alloy for casting in comparative example 1.

As illustrated in FIG. 1, a content of Cu in practical example 1 was 8.20 mass %, a content of Cu in practical example 2 was 10.12 mass %, a content of Cu in practical example 3 was 11.88 mass %, a content of Cu in practical example 8 was 15.02 mass %, and a content of Cu in practical example 10 was 16.98 mass %. As illustrated in FIG. 3 to FIG. 7, in any of practical examples 1, 2, 3, 8, and 10, a Cu-based intermetallic compound phase 30 was crystallized substantially evenly over a substantially whole area of an aluminum alloy. Furthermore, in any of practical examples 1, 2, 3, 8, and 10, adjacent Cu-based intermetallic compound phases 30 were continuously distributed in a state where they were linked to one another, and a network with a netlike shape was formed among some Cu-based intermetallic compound phases 30. As a result, as illustrated in FIG. 1, it was possible to improve a tensile strength of an aluminum alloy for casting in any of practical examples 1, 2, 3, 8, and 10. Moreover, as illustrated in FIG. 4 to FIG. 6, in any of practical examples 2, 3, and 8, Cu-based intermetallic compound phases 30 that composed a net, themselves, were grown thick, and a network with a netlike shape was extended so as to distribute over a substantially whole area of an aluminum alloy. As a result, as illustrated in FIG. 1, it was possible to further improve a tensile strength of an aluminum alloy for casting in any of practical examples 2, 3, and 8.

As illustrated in FIG. 1, a content of Cu in comparative example 2 was 18.5 mass %. As illustrated in FIG. 8, in comparative example 2, Cu-based intermetallic compound phases 30 that composed a net, themselves, were coarsened so as to have a grain shape (an agglomerate shape) and a network with a netlike shape was divided and/or broken. As a result, as illustrated in FIG. 1, it was difficult to improve a tensile strength of an aluminum alloy for casting in comparative example 2.

Thus, as a result of observation on a texture of a test piece of an aluminum alloy for casting, it could be confirmed that it was possible to cause a Si phase 10, a Ni-based intermetallic compound phase 20 and a Cu-based intermetallic compound phase 30 where crystallization regions thereof were different to coexist. Furthermore, it could be confirmed that a content of Cu was 8.01 to 18.0 mass %, so that it was possible to crystalize a Cu-based intermetallic compound phase 30 in netlike shape around a Si phase 10 and a Ni-based intermetallic compound phase 20 continuously. Moreover, it could be confirmed that a content of Cu was 9.0 to 15.5 mass %, so that it was possible to form a network with a netlike shape that was provided by a Cu-based intermetallic compound phase 30, over a substantially whole area of an aluminum alloy. As a result, as illustrated in FIG. 1, it was possible to improve a stiffness of an aluminum alloy for casting or develop such a stiffness with a small range of variation stably, and further, it was possible to improve a tensile strength thereof, in practical examples 1 to 10, as compared with comparative examples 1 and 2.

Additionally, it is also possible to apply respective compositions in the aforementioned embodiments (the first embodiment to the fifteenth embodiment) to an aluminum alloy powder for lamination formation. It is possible to manufacture an aluminum alloy powder for lamination formation by various types of powder manufacturing methods such as a water atomization method, a gas atomization method, a disk atomization method, and a plasma atomization method. The present composition is a composition of an aluminum alloy, so that it is possible to use, for example, a disk atomization method that is preferable for atomization of a material with a low melting point, for atomization of an alloy with the present composition.

An aluminum alloy powder for lamination formation where respective compositions in the aforementioned embodiments (the first embodiment to the fifteenth embodiment) are applied thereto is used, so that it is possible to provide a lamination formation product that is high in a stiffness thereof and is also excellent in a tensile strength thereof. Therefore, such a lamination formation product is preferable for a wide variety of applications that need a high stiffness and a high tensile strength thereof. For an example of an application of such a lamination formation product, an instrument for aerospace, an instrument for transportation, and an instrument for medical use, etc., and a component(s) thereof, etc., are provided in addition to an example of an application of an aluminum casting as described above. It is possible to manufacture a lamination formation product by using, for example, a metal 3D printer, etc., according to various types of three-dimensional lamination formation methods such as a powder bed method, a deposition method, and a binder jetting method.

### REFERENCE SIGNS LIST

10 Si phase
20 Ni-based intermetallic compound phase
30 Cu-based intermetallic compound phase

1-14. (canceled)

15. An aluminum alloy for casting that includes 1.0 to 10.0 mass % of Ni, 8.01 to 18.0 mass % of Cu, 0.01 to 0.75 mass % of Mn, and a balance that is Al and an inevitable impurity/impurities.

16. The aluminum alloy for casting according to claim 15, wherein a content [Cu] of Cu and a content [Ni] of Ni satisfy a following condition (1).
$$10. \leq [ Cu ] + 0.87 [ Ni ] \leq 23.5 \qquad ( 1 )$$

17. The aluminum alloy for casting according to claim 15 that further includes 5.0 to 20.0 mass % of Si.

18. The aluminum alloy for casting according to claim 17, wherein a content [Si] of Si, a content [Cu] of Cu and a content [Ni] of Ni satisfy a following condition (2).
$$30. \leq [ Si ] + 0.94 [ Cu ] + 2.02 [ Ni ] \leq 42.5 \qquad ( 2 )$$

19. The aluminum alloy for casting according to claim 17 that further includes 0.0001 to 0.1 mass % of P.

20. The aluminum alloy for casting according to claim 15 that further includes 0.01 to 3.0 mass % of Mg.

21. The aluminum alloy for casting according to claim 15, wherein a content of Cu is 9.0 to 15.5 mass %.

22. An aluminum casting that is provided by using and casting the aluminum alloy for casting according to claim 15.

23. An aluminum alloy for casting that includes 1.0 to 10.0 mass % of Ni, 8.01 to 18.0 mass % of Cu, 0.01 to 0.80 mass % of Fe, and a balance that is Al and an inevitable impurity/impurities.

24. The aluminum alloy for casting according to claim 23, wherein a content [Cu] of Cu and a content [Ni] of Ni satisfy a following condition (1).
$$10. \leq [ Cu ] + 0.87 [ Ni ] \leq 23.5 \qquad ( 1 )$$

25. The aluminum alloy for casting according to claim 23 that further includes 5.0 to 20.0 mass % of Si.

26. The aluminum alloy for casting according to claim 25, wherein a content [Si] of Si, a content [Cu] of Cu and a content [Ni] of Ni satisfy a following condition (2).
$$30. \leq [ Si ] + 0.94 [ Cu ] + 2.02 [ Ni ] \leq 42.5 \qquad ( 2 )$$

27. The aluminum alloy for casting according to claim 25 that further includes 0.0001 to 0.1 mass % of P.

28. The aluminum alloy for casting according to claim 23 that further includes 0.01 to 3.0 mass % of Mg.

29. The aluminum alloy for casting according to claim 23, wherein a content of Cu is 9.0 to 15.5 mass %.

30. An aluminum casting that is provided by using and casting the aluminum alloy for casting according to claim 23.

31. An aluminum alloy powder for lamination formation that includes 1.0 to 10.0 mass % of Ni, 8.01 to 18.0 mass % of Cu, 0.01 to 0.75 mass % of Mn, and a balance that is Al and an inevitable impurity/impurities.

32. A lamination formation product is lamination-formed by using the aluminum alloy powder for lamination formation according to claim 31.

33. An aluminum alloy powder for lamination formation that includes 1.0 to 10.0 mass % of Ni, 8.01 to 18.0 mass % of Cu, 0.01 to 0.80 mass % of Fe, and a balance that is Al and an inevitable impurity/impurities.

34. A lamination formation product is lamination-formed by using the aluminum alloy powder for lamination formation according to claim 33.
